(19) United States
(12) Patent Application Publication
(10) Pub. No.: US 2023/0299408 A1
(43) Pub. Date: Sep. 21, 2023

(54) MOBILE ENERGY STORAGE SYSTEM AND INTEGRATED SKID BASE

(71) Applicant: STEWART & STEVENSON LLC, Houston, TX (US)

(72) Inventors: Donald KOBS, Houston, TX (US); Eric EVEZIC, Houston, TX (US); Adam LAMBERTUS, Houston, TX (US); Paul SMITH, Houston, TX (US)

(21) Appl. No.: 18/184,057

(22) Filed: Mar. 15, 2023

Related U.S. Application Data
(60) Provisional application No. 63/320,249, filed on Mar. 16, 2022.

(51) Int. Cl. H01M 50/244; H01M 50/502; H01M 50/249; H01M 10/42; H01M 10/6567

(52) U.S. Cl. CPC H01M 50/244; H01M 50/502; H01M 50/249; H01M 10/425; H01M 10/6567; H01M 2010/4271

(57) ABSTRACT

An energy storage system includes a skid; one or more battery assemblies coupled to the skid, each battery assembly including at least one battery; an enclosure, the enclosure coupled to the skid and enclosing the one or more battery assemblies; a bus bar assembly operatively coupled to each battery; a power electronics rack; a transformer; and a thermal management system.

### CROSS-REFERENCE TO RELATED APPLICATIONS

This application is a nonprovisional application which claims priority from U.S. provisional application No. 63/320,249, filed Mar. 16, 2022, which is incorporated by reference herein in its entirety.

### TECHNICAL FIELD/FIELD OF THE DISCLOSURE

The present disclosure relates generally to energy storage, and specifically to mobile energy storage systems.

### BACKGROUND OF THE DISCLOSURE

An electric microgrid may include various distributed energy resources that produce energy for a specific geographic location. Microgrids can be engineered to work in conjunction with traditional electrical grids but may provide enhanced grid resiliency by operating independently.

Microgrids can serve as a resource for improved system recovery, and by using local energy resources, microgrids may reduce the energy losses often experienced in traditional transmission and distribution systems. By enabling mobility with the microgrid, energy resources can be moved as needed to serve a broader coverage area and meet energy need demand.

Electrical power generation, distribution, and storage may be especially important when operating at remote or otherwise unimproved locations without access to or without consistent access to a traditional electrical grid. The ability to store power in such a microgrid may provide for more consistent availability and dependability while allowing generators to be run less frequently or at a more efficient rate despite low power needs.

### SUMMARY

The present disclosure provides for an energy storage system. The energy storage system may include a skid. The energy storage system may include one or more battery assemblies coupled to the skid, each battery assembly including at least one battery. The energy storage system may include an enclosure, the enclosure coupled to the skid and enclosing the one or more battery assemblies. The energy storage system may include a bus bar assembly operatively coupled to each battery, a power electronics rack, a transformer, and a thermal management system.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a side view of an energy storage system consistent with at least one embodiment of the present disclosure.

FIG. 2 depicts a perspective view of the energy storage system of FIG. 1 with the outer enclosure removed.

FIG. 2A depicts a perspective view of a lower isolation mount consistent with at least one embodiment of the present disclosure.

FIG. 2B depicts a perspective view of an upper isolation mount consistent with at least one embodiment of the present disclosure.

FIG. 3 depicts a top view of a bus bar system of an energy storage system consistent with at least one embodiment of the present disclosure.

FIG. 3A depicts a perspective partially disassembled view of the bus bar system of FIG. 3.

FIG. 3B depicts a partial cross section view of the bus bar system of FIG. 3.

FIG. 3C depicts a detail perspective view of a portion of the energy storage system of FIG. 3.

FIG. 4 depicts a perspective view of a bus bar rack of an energy storage system consistent with at least one embodiment of the present disclosure.

FIG. 4A depicts a schematic view of an energy storage system consistent with at least one embodiment of the present disclosure.

FIG. 5 depicts a perspective view of a thermal management system of an energy storage system consistent with at least one embodiment of the present disclosure.

FIGS. 5A, 5B depict a schematic view of the thermal management system of FIG. 5.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

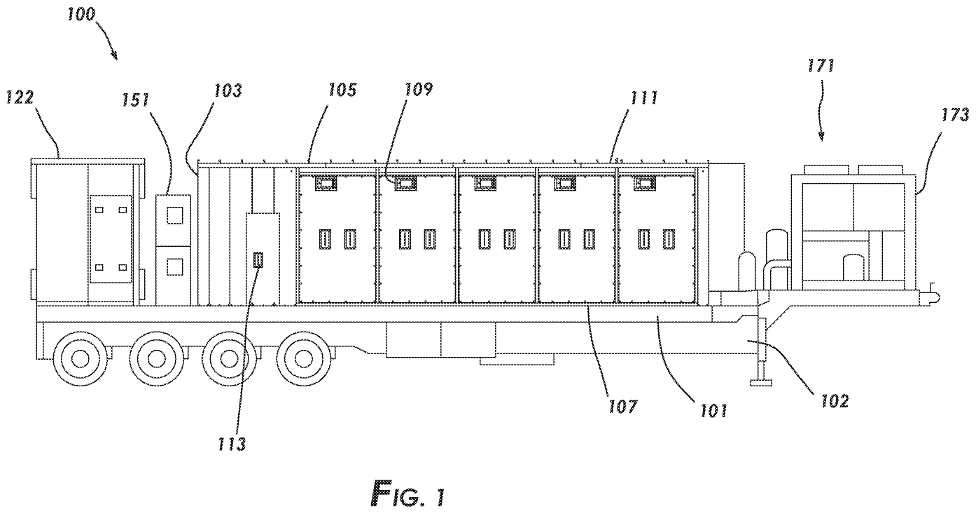

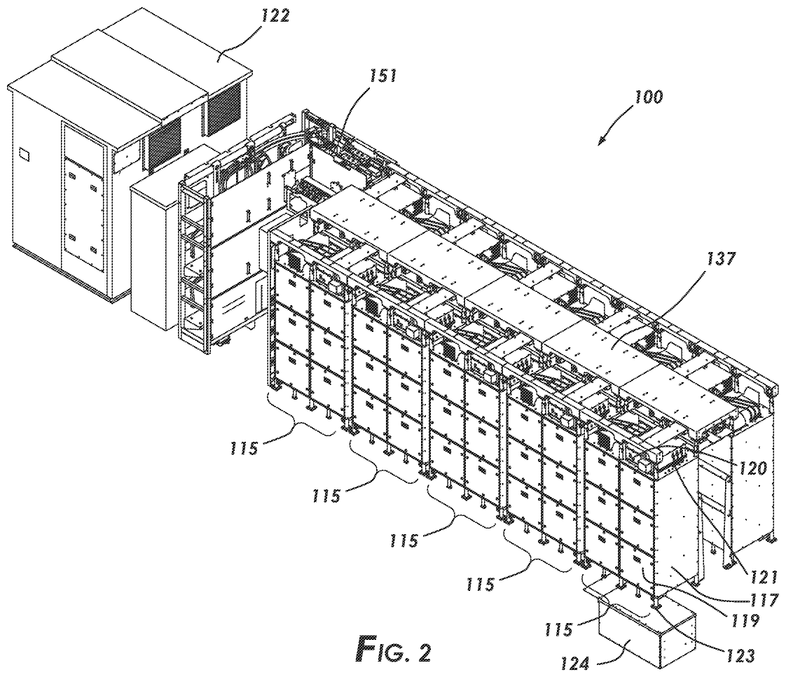

FIG. 1 depicts a side view of energy storage system 100 consistent with at least one embodiment of the present disclosure. Energy storage system 100 may include skid 101. Skid 101 may provide a base and support for energy storage system 100. In some embodiments, skid 101 may include equipment used to transport energy storage system 100 by truck including, for example and without limitation, winch points, roll bars, or other features. In other embodiments, skid 101 may be integrated into trailer 102 for transportation of energy storage system 100.

In some embodiments, energy storage system 100 may include outer enclosure 103. Outer enclosure 103 may be mechanically coupled to skid 101 and may house the components of energy storage system 100 including, for example and without limitation, providing environmental protection to the components and protection from shock and arcing to personnel in the vicinity of energy storage system 100. In some embodiments, outer enclosure 103 may include roof 105. In some embodiments, outer enclosure 103 and/or roof 105 may include louvres for ventilation requirements such as, for example and without limitation to account for off-gassing of batteries or other equipment within outer enclosure 103. In some embodiments, such louvres may be actuatable by motors or other actuation devices. In some embodiments, outer enclosure 103 may be removable from the rest of energy storage system 100 by, for example and without limitation, lifting with an overhead crane system.

In some embodiments, outer enclosure 103 may include one or more battery access panels 107. Battery access panels 107 may be positioned to generally correspond with the position of one or more batteries, as further discussed below, positioned within outer enclosure 103. Battery access panels 107 may allow access to the battery or batteries and any associated electronics from outside of energy storage system 100. In some embodiments, each battery access panel 107 may include latch 109 positioned to keep battery access panel 107 closed while allowing for selective access to the battery or batteries positioned therewithin. In some embodiments, battery access panels 107 may include clear panel 111 positioned to allow for visual inspection of batteries or electronics within battery access panels 107 such as, for example and without limitation, status lights, without necessitating the opening of battery access panels 107. In some embodiments, battery access panels 107 may include a seal positioned around the perimeter thereof to reduce or prevent the ingress of dust or water from the surrounding environment into the interior of outer enclosure 103.

In some embodiments, outer enclosure 103 may include additional access doors such as interior access door 113 to allow personnel entry to the interior of outer enclosure 103.

In some embodiments, thermal insulation may be applied to interior surfaces of outer enclosure 103 which may, for example and without limitation, help maintain interior climate conditions and mitigate environmental fluctuations outside the enclosure. The insulation material may include one or more of mass loaded vinyl panels, mineral wool, urethane faced foam, or acoustical foam.

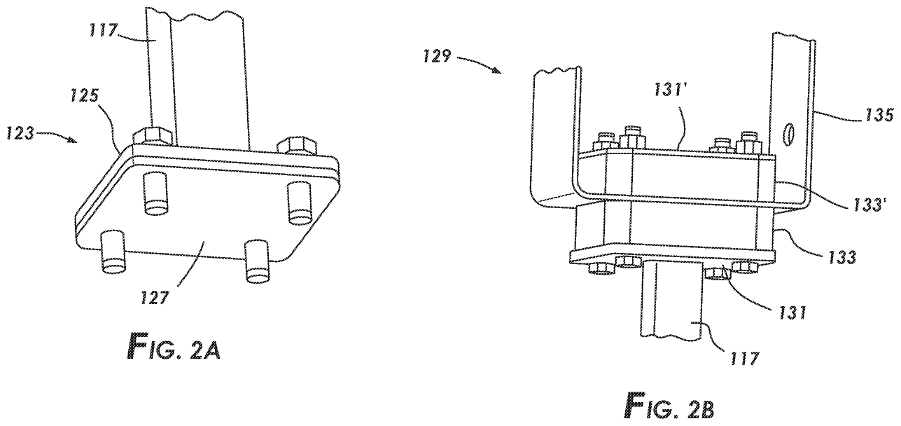

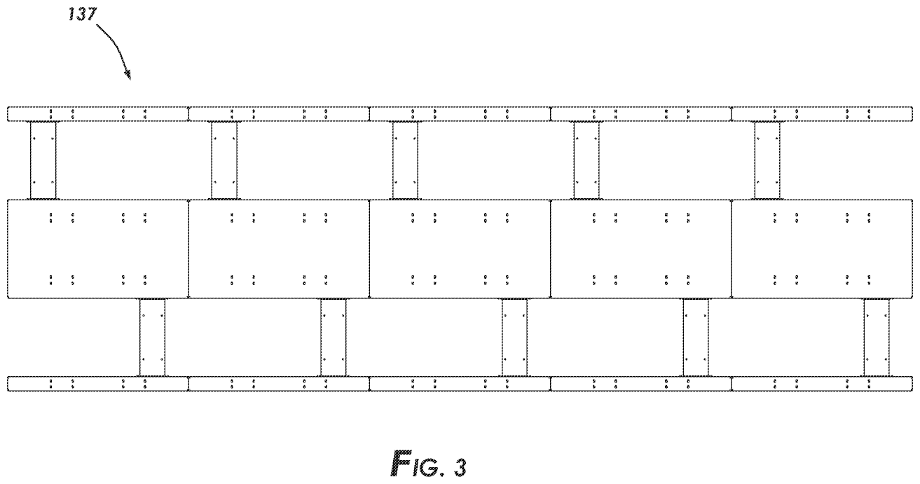

FIG. 2 depicts a perspective view of energy storage system 100 consistent with at least one embodiment of the present disclosure with outer enclosure 103 removed. In some embodiments, energy storage system 100 may include battery assemblies 115. Battery assemblies 115 may be positioned throughout the interior of energy storage system 100 arranged such that each battery assembly 115 is accessible from outside outer enclosure 103 through a corresponding battery access panel 107. In some embodiments, each battery assembly 115 may include rack 117, which may be a frame coupled to skid 101 and used to support and house one or more batteries 119 and any associated electrical equipment 121 corresponding to batteries 119. Batteries 119 may be stacked vertically within rack 117. In some embodiments, each battery assembly 115 may include integrated battery management system (BMS) 120. Each BMS 120 may operate to monitor and report operational conditions including, for example and without limitation, one or more of state of charge of any batteries 119 positioned in battery assembly 115, battery assembly state of health, cell temperatures, and cell voltages.

In some embodiments, each battery assembly 115 may mechanically couple to skid 101 by one or more lower isolation mounts 123 as shown in FIG. 2A. Each lower isolation mount 123 may include bracket 125 coupled to rack 117 and flexible plate 127 positioned between bracket 125 and skid 101. In some embodiments, each battery assembly 115 may mechanically couple to outer enclosure 103 by one or more upper isolation mounts 129 as shown in FIG. 2B. Each upper isolation mount 129 may include bracket 131 coupled to rack 117 and flexible plate 133 positioned between bracket 131 and mounting bracket 135 of outer enclosure 103. In some embodiments, upper isolation mounts 129 may be bidirectional and may include second flexible plate 133′ positioned between mounting bracket 135 and bracket 131′ coupled to bracket 131.

Lower isolation mounts 123 and upper isolation mounts 129 may, for example and without limitation, mitigate the effects of shock loading and vibration during operation and transportation of energy storage system 100.

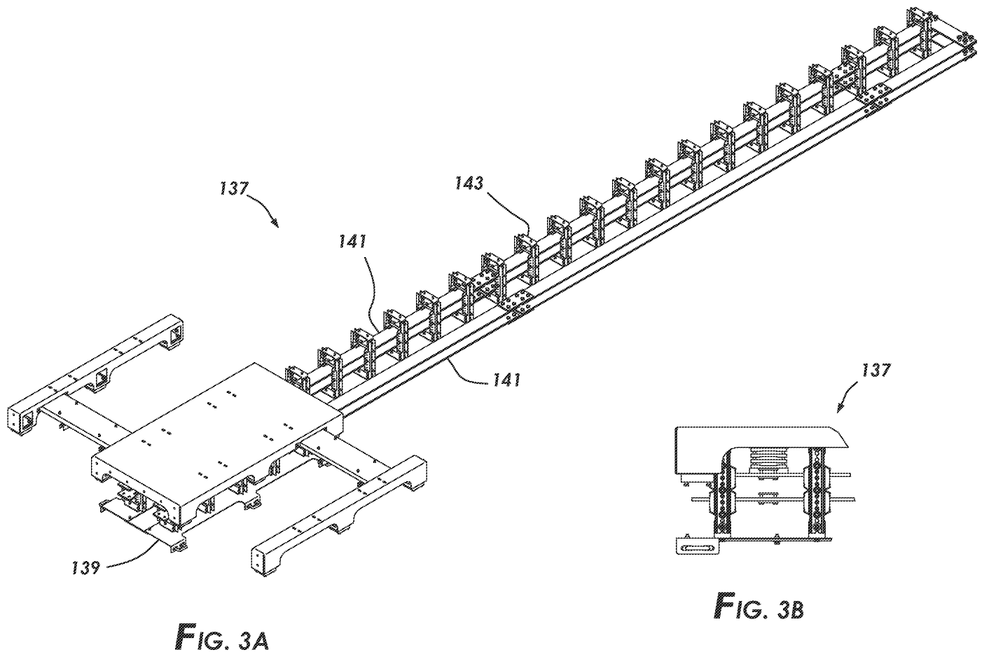

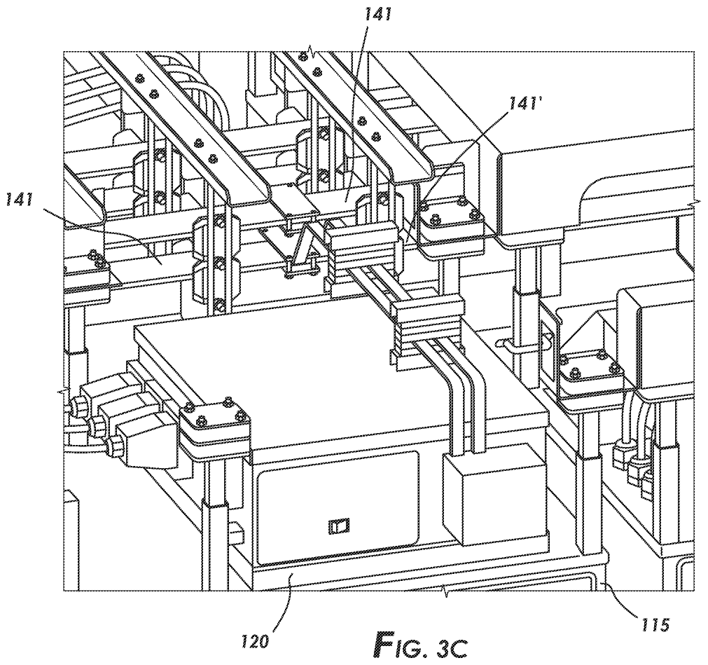

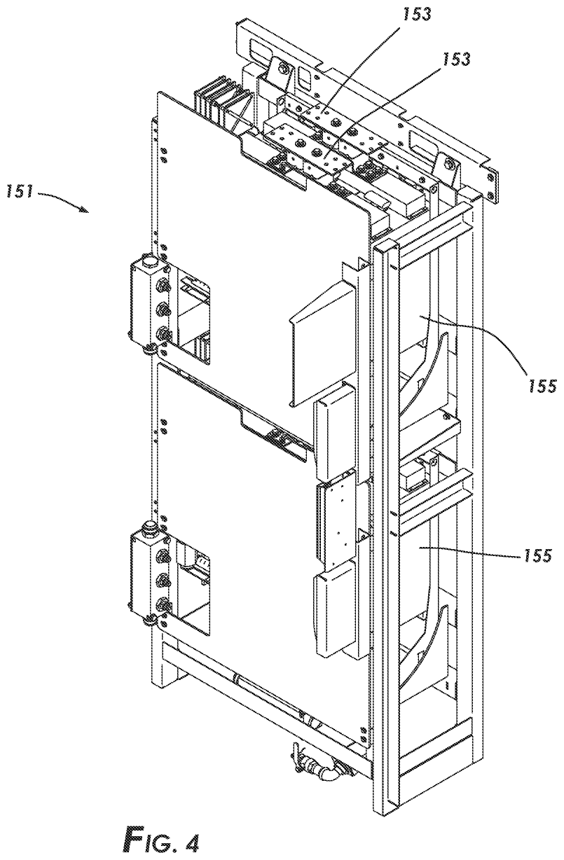

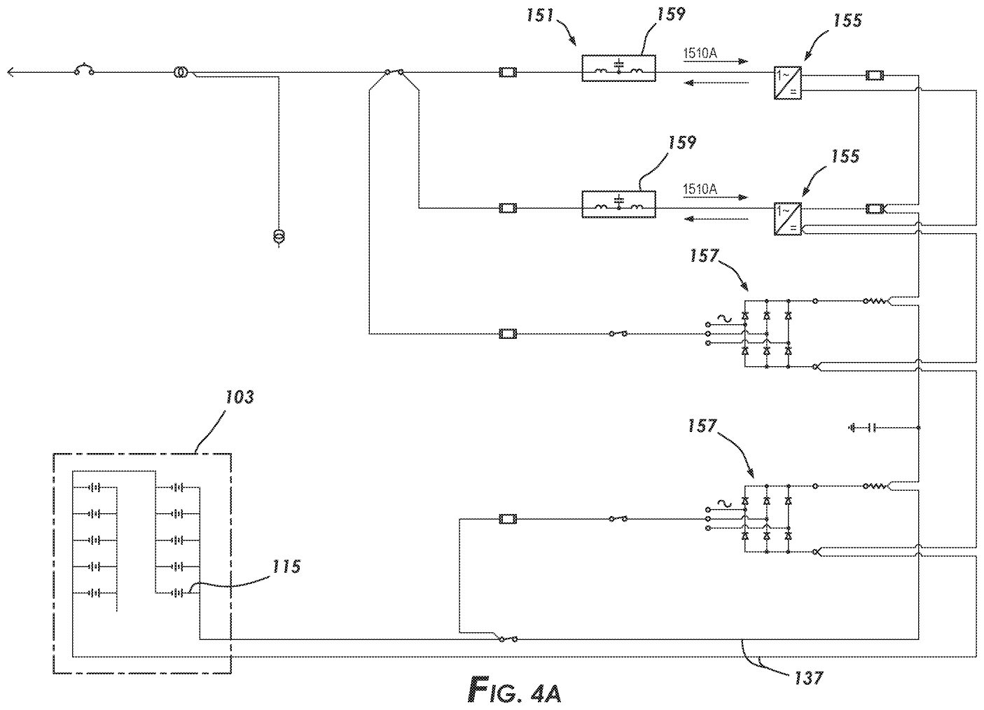

With reference to FIG. 2, the terminals of battery assemblies 115 may be operatively coupled in parallel to bus bar system 137. Bus bar system 137 may be positioned above battery assemblies 115 near the top of outer enclosure 103. Bus bar system 137 is further shown in FIGS. 3, 3A, 3B, and 3C. In some embodiments, bus bar system 137 may be mounted to roof 105 of outer enclosure 103. In some embodiments, bus bar system 137 may include a transparent cover 139 positioned parallel to the interior of roof 105 of outer enclosure 103. Bus bar system 137 may further include bus bars 141. Bus bars 141 may be electrically coupled to battery assemblies 115, as shown in FIG. 3C, by battery bus bars 141′. Bus bars 141 may extend along the length of energy storage system 100 and may serve to carry power to and from battery assemblies 115. In some embodiments, transparent cover 139 may, for example and without limitation, allow for regular inspection of bus bar system 137 without requiring the disassembly thereof. In some embodiments, transparent cover 139 may be formed from a non-conductive material to, for example and without limitation, protect operators against electrical shock and arc flash risk. In some embodiments, isolator 143 may be positioned about bus bars 141 to, for example and without limitation, protect against vibration transmission and shock loading during travel and operation.

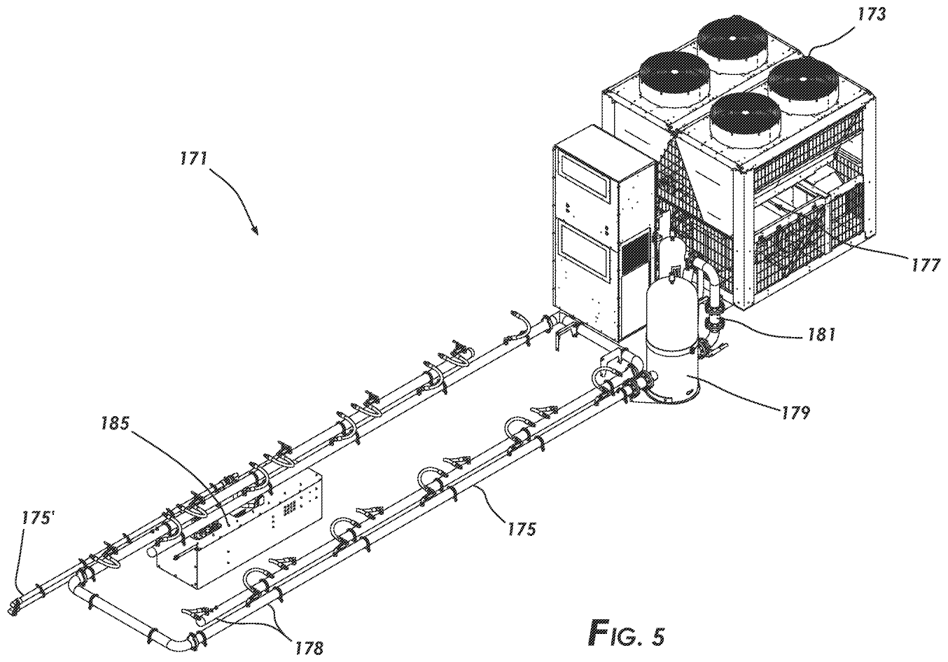

In some embodiments, as shown in FIG. 2, bus bar system 137 may connect battery assemblies 115 to power electronics rack 151. Power electronics rack 151, as shown in FIGS. 4, 4A, may include terminals 153 positioned to couple to bus bars 141 and make electrical connection therewith. Power electronics rack 151 may include, for example and without limitation, one or more of active front ends 155 AC drives 157, LCL filters 159, and other components. In some embodiments, AC power from such equipment may be supplied to transformer 122, which may power systems of energy storage system 100 and provide power to export to external equipment connected to energy storage system 100 such as a microgrid. In some embodiments, energy storage system 100 may include neutral grounding resistor 124.

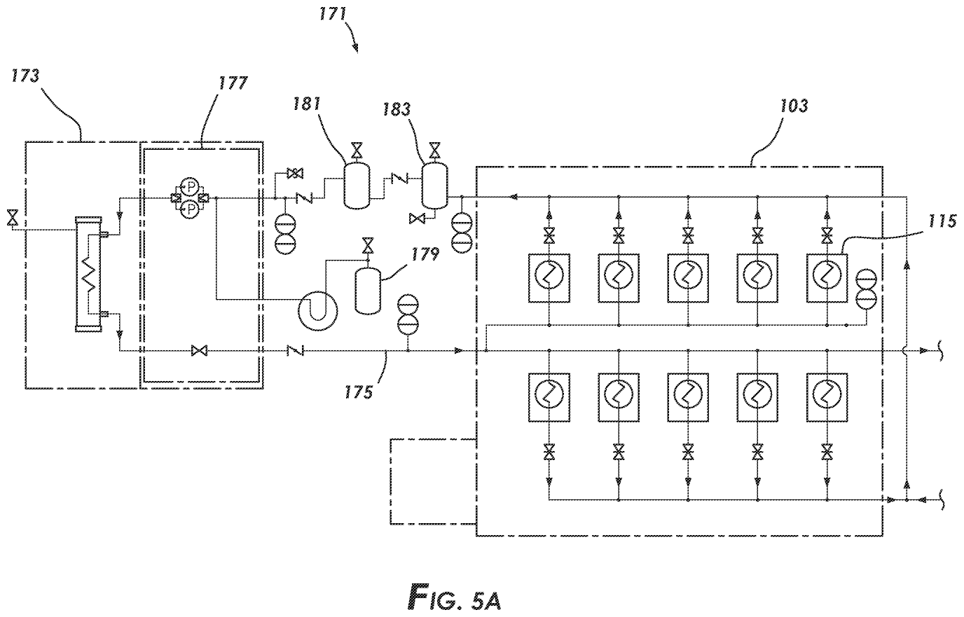

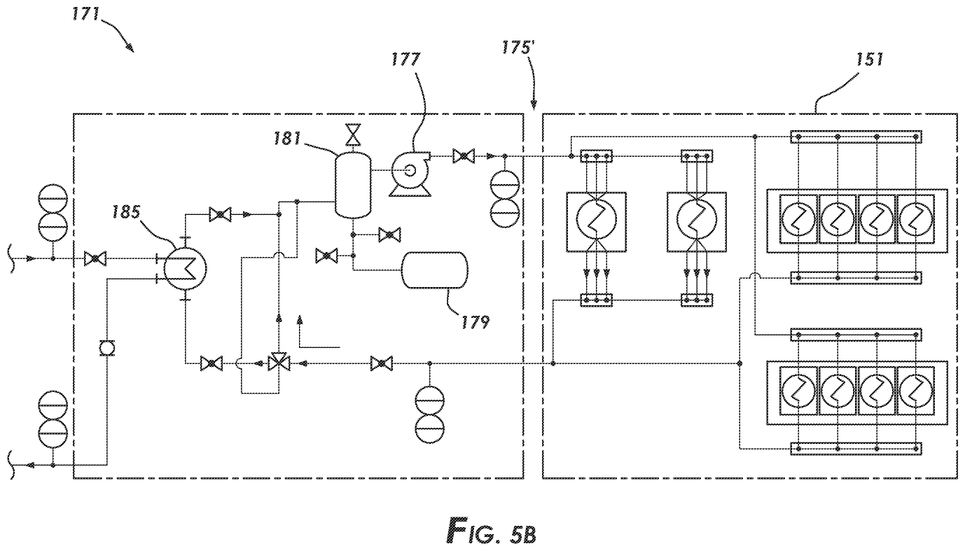

In some embodiments, energy storage system 100 may include thermal management system 171. Thermal management system 171, shown in FIGS. 5, 5A, 5B, may include chiller 173 and coolant circuit 175. Coolant circuit 175 may circulate coolant from chiller 173 using one or more hydronic pumps 177 to components of energy storage system 100 including, for example and without limitation, battery assemblies 115 and power electronics rack 151, thereby allowing for the temperature of the components of energy storage system 100 to be managed. In some embodiments, coolant circuit 175 serving battery assemblies 115 (such as shown in FIG. 5A) may be separate from secondary coolant circuit 175′ serving power electronics rack 151 (such as shown in FIG. 5B). In some embodiments, thermal management system 171 may include one or more additional components including, for example and without limitation, expansion tanks 179, air separators 181, and buffer tanks 183. In some embodiments, heat exchanger 185 may be positioned to transfer heat from cooling circuit 175 to secondary cooling circuit 175′ used with power electronics rack 151 to cooling circuit 175 used with battery assemblies 115, as power electronics rack 151 may not be cooled to the same extent as battery assemblies 115.

In some embodiments, coolant circuits 175 may be integrated into or positioned on skid 101 below battery assemblies 115 and power electronics rack 151. In some embodiments, coolant circuits 175 may couple to battery assemblies 115 and power electronics rack 151 by flexible couplings 178 to, for example and without limitation, mitigate the effects of shock and vibration during transport and operation of energy storage system 100.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An energy storage system comprising:
a skid;
one or more battery assemblies coupled to the skid, each battery assembly including at least one battery;
an enclosure, the enclosure coupled to the skid and enclosing the one or more battery assemblies;
a bus bar assembly operatively coupled to each battery;
a power electronics rack;
a transformer; and
a thermal management system.

2. The energy storage system of claim 1, wherein the skid is integrated into a trailer.

3. The energy storage system of claim 1, wherein the enclosure is removable from the skid.

4. The energy storage system of claim 1, wherein the enclosure further comprises one or more battery access panels, each battery access panel aligned with one or more corresponding battery assemblies.

5. The energy storage system of claim 1, wherein the enclosure further comprises an interior access door.

6. The energy storage system of claim 1, wherein the enclosure comprises one or more louvres.

7. The energy storage system of claim 1, wherein each battery assembly comprises a battery management system.

8. The energy storage system of claim 1, wherein the bus bar assembly is positioned at or near the top of the interior of the enclosure.

9. The energy storage system of claim 1, wherein the thermal management system comprises:
a chiller;
a hydronic pump; and
a coolant circuit, the coolant circuit operatively coupled to the hydronic pump and chiller such that the chiller cools a coolant within the coolant circuit and the hydronic pump circulates the coolant through the coolant circuit.

10. The energy storage system of claim 9, wherein the coolant circuit is positioned in the skid.

11. The energy storage system of claim 9, wherein the coolant circuit fluidly couples to each battery assembly by a flexible connection.

12. The energy storage system of claim 9, wherein the thermal management system includes a second coolant circuit, the second coolant circuit fluidly coupled to the power electronics rack.
